(19) United States
(12) Patent Application Publication
(10) Pub. No.: US 2011/0097106 A1
(43) Pub. Date: Apr. 28, 2011

(54) IMAGE FORMING APPARATUS

(75) Inventor: Kazuhiro Hosohara, Suntou-gun (JP)

(73) Assignee: CANON KABUSHIKI KAISHA, Tokyo (JP)

(21) Appl. No.: 12/911,208

(22) Filed: Oct. 25, 2010

(30) Foreign Application Priority Data
Oct. 28, 2009 (JP) 2009-248062

(51) Int. Cl. G03G 15/16

(52) U.S. Cl. 399/101

(57) ABSTRACT

An image forming apparatus includes an image bearing member, an intermediary transfer member receiving the toner image on the image bearing member, a transfer unit for transferring the toner image from the intermediary transfer member onto a sheet, and a rotatable cleaner for cleaning the intermediary transfer member. The cleaner is downstream of the transfer unit with respect to a sheet conveyance direction and rotates in an opposite direction to the intermediary transfer member during image formation. The cleaner separates a sheet wound about the intermediary transfer member from the intermediary transfer member.

### FIELD OF THE INVENTION AND RELATED ART

The present invention relates to an image forming apparatus to which a cartridge is detachably mountable and which is of an electrophotographic type.

Examples of the image forming apparatus of the electrophotographic type may include an electrophotographic copying machine, an electrophotographic printer (such as a laser beam printer or an LED printer), and the like. The cartridge may be a process cartridge or a developing cartridge. The cartridge is detachably mountable to a main assembly of the image forming apparatus and contributes to an image forming process for forming an image on a recording material. Here, the process cartridge are prepared by integrally assembling a photosensitive drum and at least one of a charging unit, a developing unit, and a cleaning unit which are a process unit, into a cartridge which is detachably mountable to the image forming apparatus main assembly. Further, the developing cartridge is prepared by integrally assembling a developing device for accommodating toner (developer) and a member for effecting development with the toner on the electrophotographic photosensitive drum, into a cartridge which is detachably mountable to the image forming apparatus main assembly. Thus, the cartridge can be mounted to and dismounted from the image forming apparatus main assembly by a user himself (herself), so that maintenance of the main assembly can be easily performed.

In the image forming apparatus, an intermediary transfer member is used in some cases. Image formation is effected by transferring a toner image from the photosensitive drum onto the intermediary transfer member and then by transferring the toner image from the intermediary transfer member onto the recording material such as paper or a sheet. When the toner image was transferred onto the sheet, the sheet after the transfer was wound about the intermediary transfer member without being separated to cause jam. Particularly, in a constitution in which curvature of the intermediary transfer member is large, in the case where the toner image was transferred onto thin paper or the like having low rigidity or in the case where the sheet before the transfer was curled, the sheet after the transfer was wound about the intermediary transfer member without being separated to cause jam.

Japanese Laid-Open Patent Application (JP-A) 2002-296917 discloses a technique such that the sheet is separated from the intermediary transfer member by a separation roller or a separation claw which contact the intermediary transfer member from which the toner image has been transferred onto the sheet. Further, JP-A 2003-084575 discloses a technique such that winding of the sheet about the intermediary transfer member is prevented by providing a roller pair, a bent portion or the like, which provides curvature with respect to an opposite direction to that of the intermediary transfer member, on an upstream side of a contact position between the intermediary transfer member and a transfer roller with respect to a sheet conveyance direction.

However, in the conventional techniques described above, there is a need to provide a member dedicated to prevention of the winding of the sheet about the intermediary transfer member or a member dedicated to separation of the sheet wound about the intermediary transfer member. For this reason, a problem of an increase in cost of the image forming apparatus and a problem of upsizing of the entire image forming apparatus occur.

### SUMMARY OF THE INVENTION

A principal object of the present invention is to provide an image forming apparatus, capable of preventing jam due to winding of a sheet about an intermediary transfer member, which is inexpensive and small in size.

According to an aspect of the present invention, there is provided an image forming apparatus comprising:

an image bearing member for bearing a toner image;

an intermediary transfer member which is rotatable and onto which the toner image borne on the image bearing member is to be transferred in contact with the image bearing member;

a transfer unit for transferring the toner image from the intermediary transfer member onto a sheet: and

a rotatable cleaning member for cleaning the intermediary transfer member in contact with the intermediary transfer member, the rotatable cleaning member being disposed downstream of the transfer unit with respect to a sheet conveyance direction and being to be rotated in an opposite direction to a rotational direction of the intermediary transfer member during image formation;

wherein the rotatable cleaning member is capable of separating a sheet wound about the intermediary transfer member from the intermediary transfer member, and

wherein, in a sheet conveyance area with respect to a sheet width direction and in a spatial area defined by three lines connecting three points consisting of a contact point between a common tangential line and the intermediary transfer member, a contact point between the common tangential line and the rotatable cleaning member, and a contact point between the intermediary transfer member and the rotatable cleaning member, the common tangential line being simultaneously in contact with a surface of the intermediary transfer member and a surface of the rotatable cleaning member on an upstream side of the contact point between the intermediary transfer member and the rotatable cleaning member with respect to the rotational direction of the rotatable cleaning member, only the rotatable cleaning member is contacted to the intermediary transfer member.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a perspective view of an outer appearance of an image forming apparatus of the present invention.

FIG. 2 is a sectional view showing a schematic general structure of the image forming apparatus of the present invention.

FIG. 3 is a sectional view showing an image forming unit to be mounted in the image forming apparatus of the present invention.

FIG. 4 is a perspective view of an outer appearance of an intermediary transfer drum cleaning unit in First Embodiment of the present invention.

FIG. 5 is a sectional view for illustrating a common tangential line between an intermediary transfer drum and a cleaning roller in First Embodiment of the present invention.

FIG. 6 is a sectional view showing the common tangential line between the intermediary transfer drum and the cleaning roller and showing an area connecting contact points (points of contact) with respect to respective rollers.

FIGS. 7, 8 and 9 are schematic views for illustrating a state in which a sheet is separated from the intermediary transfer drum in First Embodiment of the present invention.

FIG. 10 is a sectional view during exchange of a developing cartridge of the image forming apparatus in First Embodiment of the present invention.

### DESCRIPTION OF THE PREFERRED EMBODIMENTS

Hereinbelow, embodiments of the present invention will be described with reference to the drawings. However, dimensions, materials, shapes and relative configurations of constituent parts described in the following embodiments can be appropriately changed depending on constitutions and various conditions of an image forming apparatus to which the present invention is applied.

### First Embodiment

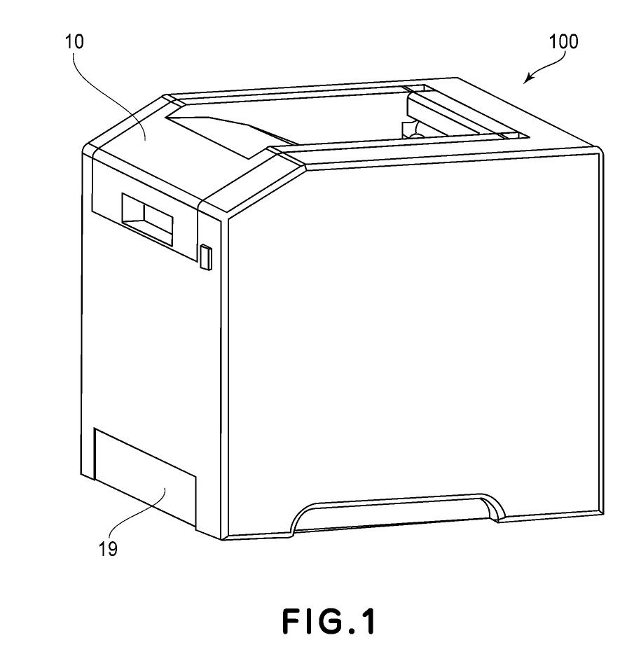

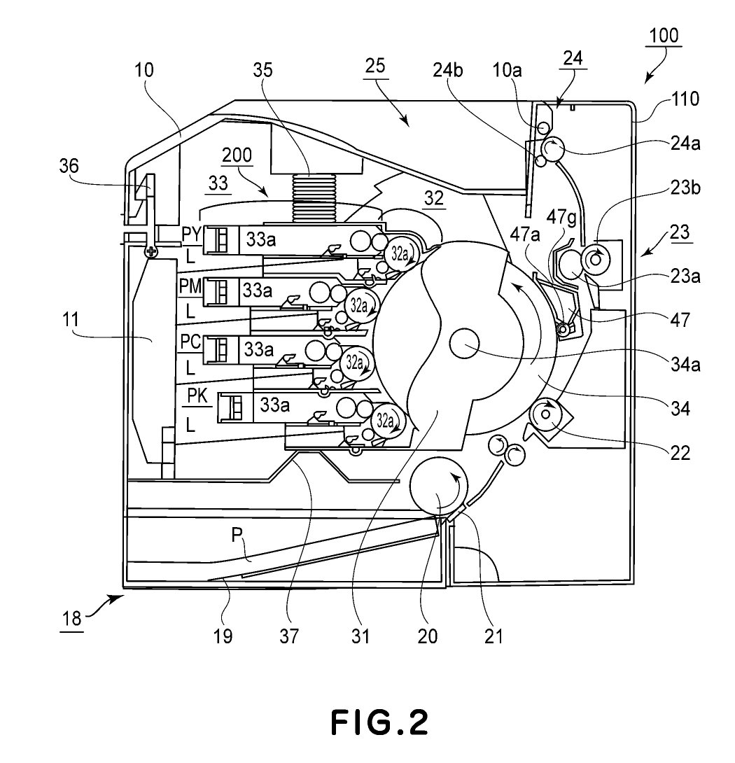

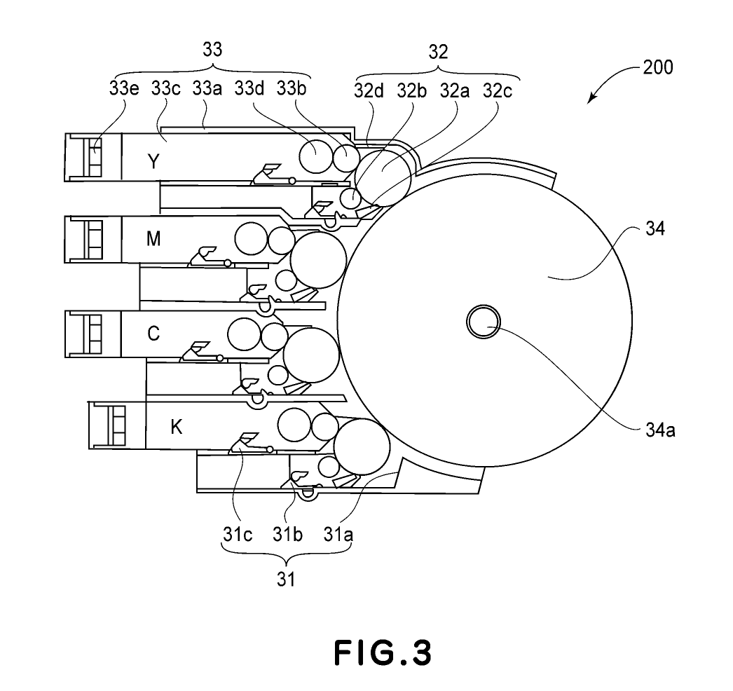

A schematic general structure of an image forming apparatus 100 will be described with reference to the drawings. FIG. 1 is a perspective view of an outer appearance of the image forming apparatus 100 of the present invention, FIG. 2 is a sectional view of the image forming apparatus 100, and FIG. 3 is a sectional view of an image forming unit 200. The image forming apparatus 100 is a four-color based laser beam printer. The image forming apparatus 100 effects image formation on a sheet as a recording material on the basis of an electrical image signal input from an external host device (not shown) such as a personal computer, an image reader, or a remote facsimile machine.

In the following description, with respect to the image forming apparatus 100 (also referred to as an apparatus main assembly 100), a front side (direction) is a side (direction) on which a (sheet) feeding cassette 19 is pulled out. A rear side (direction) is an opposite side (direction) to the front side (direction). An upper side (direction) is a side (direction) on which a maintenance cover 10 is opened. A front-rear direction is a (front) direction from the rear side toward the front side of the apparatus main assembly 100 and a (rear) direction opposite from the front direction. Left and right are those as seen from the front side of the apparatus main assembly 100. A left-right direction is a (left) direction from right toward left and a (right) direction opposite from the left direction.

Inside the apparatus main assembly 100, as shown in FIG. 3, the image forming unit 200 is disposed. The image forming unit 200 includes a sub-frame 31 detachably mountable to a main frame 110 of the image forming apparatus 100 shown in FIG. 2, a plurality of photosensitive units 32 disposed on the sub-frame 31 with a predetermined spacing, and an intermediary transfer drum 34 as an intermediary transfer member rotatably attached to the sub-frame 31. Onto the intermediary transfer drum 34, a toner image borne one a photosensitive drum 32a as an image bearing member is to be transferred in contact with the photosensitive drum 32a. A developing cartridge 33 for supplying a developer (toner) to the photosensitive unit 32 is connected with the image forming unit 200.

The sub-frame 31 includes an intermediary transfer member frame 31a for supporting the intermediary transfer drum 34, a photosensitive member supporting unit 31b for supporting the photosensitive unit 32, and a developing device connecting unit 31c for temporarily holding the developing cartridge 33 mounted in the image forming unit 200. The intermediary transfer member frame 31a has a shape for supporting end portions of a center shaft 34a of the intermediary transfer drum 34 and a shape for guiding the developing cartridge 33 so as to be connected with the photosensitive unit 32 at portions except a central portion contactable to a sheet P and which opposes the main frame 110. Further, the central portion of the intermediary transfer drum 34 is directed to the sheet P and the photosensitive unit 32.

The photosensitive unit 32 includes the photosensitive drum 32a as a first image bearing member on which the toner image is borne and a charging roller 32b as a process means acting on the photosensitive drum 32a. The photosensitive unit 32 further includes a cleaning device 32c for removing the developer remaining on the surface of the photosensitive drum 32a and a photosensitive member case 32d connected with the photosensitive member supporting unit 31b of the sub-frame 31. The photosensitive unit 32 is provided in plurality with a predetermined spacing so as to oppose the intermediary transfer drum 34.

The developing cartridge 33 includes a developing device case 33a connected with the developing device connecting unit 31c of the sub-frame 31 and a developing roller 33b, provided at one end of the developing device case 33a, as a developer holding unit for supplying the developer to the photosensitive drum 32a. Further, the developing cartridge 33 includes a developing device 33c for accommodating the developer, a feeding roller 33d for forming the developer in the developing device 33c to the developing roller 33b, and a contact point unit 33e for urging the developing roller 33b against the photosensitive drum 32a with a predetermined pressure. The developing roller 33b may be in contact with or separated from the photosensitive drum 32a.

At a front portion of the developing cartridge 33, a laser scanner unit 11 as an exposure means is disposed. The laser scanner unit 11 outputs laser light L modulated correspondingly to image information for each color input from the external host device, so that each of the photosensitive drums 32a is subjected to scanning exposure.

At a lower portion of the image forming unit 200, a (sheet) feeding unit 18 is disposed. The feeding unit 18 includes the feeding cassette 19, a feeding roller 20, a separation pad 21, and the like. The feeding cassette 19 is a front loading type in which it can be freely pulled out from the front side and inserted into the apparatus main assembly 100.

At a rear upper portion inside the apparatus main assembly (image forming apparatus) 100, a fixing means 23 and a discharging roller pair 24 are disposed. An upper surface of the apparatus main assembly 100 constitutes a discharging tray 25. The fixing means 23 is of the type using a fixing film unit 23a and a pressing roller 23b. The discharging roller pair 24 includes discharging rollers 24a and 24b.

Each of the photosensitive units 32 in a state in which it is mounted at a mounting position inside the apparatus main assembly 100 has a drive input portion, for the photosensitive unit 32, connected to a drive output portion of the apparatus main assembly 100. Further, to electrical contacts of the photosensitive unit 32, an energization system of the apparatus main assembly 100 is electrically connected.

An operation for forming a full-color image is as follows. As shown in FIG. 2, the photosensitive drum 32a of each of the photosensitive units 32 is rotationally driven in a clockwise direction indicated by an arrow at a predetermined control speed. The intermediary transfer drum 34 is also rotationally driven in a counterclockwise direction (following the rotation of the photosensitive drum 32a) indicated by an arrow at a speed corresponding to the speed of the photosensitive drum 32a. The laser scanner unit 11 is also driven. In synchronism with this drive, in each of the photosensitive units 32, the charging roller 32b uniformly charges the surface of the photosensitive drum 32a to a predetermined-polarity potential. The laser scanner unit 11 scans and exposes the surface of the photosensitive drum 32a with the laser light L which has been modulated depending on an image signal for each color. As a result, on the surface of each photosensitive drum 32a, an electrostatic latent image for an associated color is formed. The thus formed electrostatic latent image is developed into the toner image by the developing cartridge 33.

By an electrophotographic image forming process operation as described above, on a first photosensitive drum 32a, a yellow (Y) toner image corresponding to a yellow component of the full-color image is formed and then the toner image is primary-transferred onto the intermediary transfer drum (intermediary transfer member) 34.

On a second photosensitive drum 32a, a magenta (M) toner image corresponding to a magenta component of the full-color image is formed and then the toner image is primary-transferred superposedly onto the Y toner image which has already been transferred onto the intermediary transfer drum 34.

On a third photosensitive drum 32a, a cyan (Y) toner image corresponding to a cyan component of the full-color image is formed and then the toner image is primary-transferred onto the Y toner image and the M toner image which have already been transferred onto the intermediary transfer drum 34.

On a fourth photosensitive drum 32a, a black (K) toner image corresponding to a black component of the full-color image is formed and then the toner image is primary-transferred superposedly onto the Y toner image, the M toner image and the C toner image which have already been transferred onto the intermediary transfer drum 34.

As a result, on the intermediary transfer drum 34, unfixed toner images of the four colors are synthetically formed. Transfer residual toner remaining on the surface of each photosensitive drum 32a after the toner image is primary-transferred onto the intermediary transfer drum 34 is removed by the cleaning device 32c.

On the other hand, the feeding roller 20 is driven with predetermined control timing. As a result, by a cooperation of the feeding roller 20 and the separation pad 21, the sheets P stacked in the feeding cassette 19 is separated and fed one by one. Then, the sheet P is introduced into a nip (secondary transfer nip) between the intermediary transfer drum 34 and a secondary transfer roller 22 for transferring the toner image from the intermediary transfer drum (intermediary transfer member) 34 onto the sheet P. As a result, the four color toner images on the intermediary transfer drum 34 are successively and collectively transferred onto the sheet P in a process in which the sheet P is nip-conveyed in the nip. Incidentally, in FIG. 2, a sub-frame urging spring 35, a maintenance button 36 and a main stay 37 are disposed.

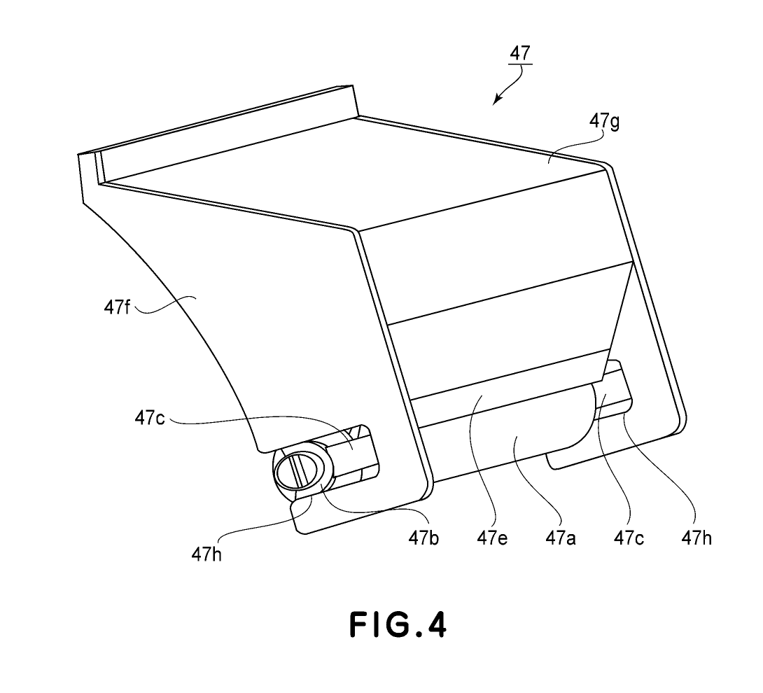

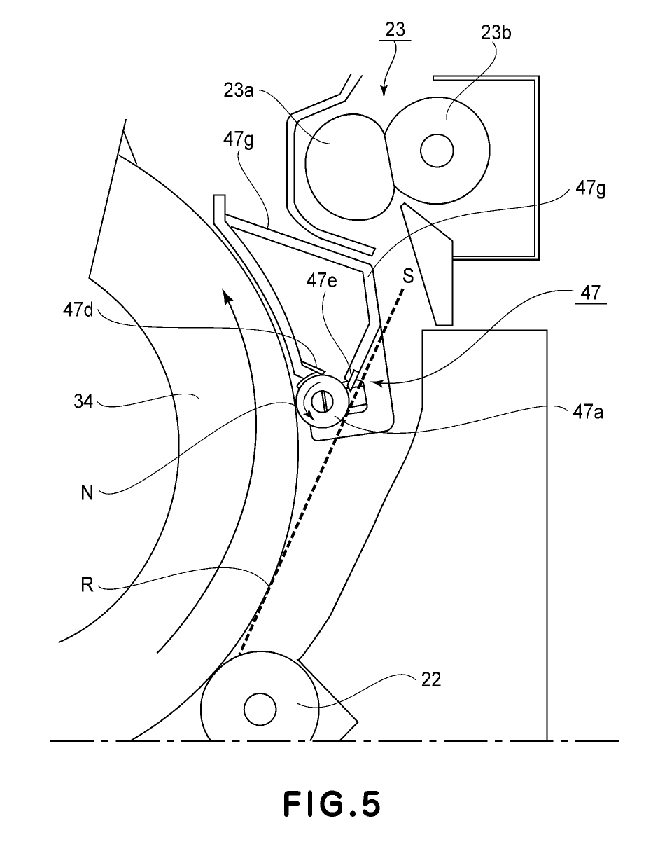

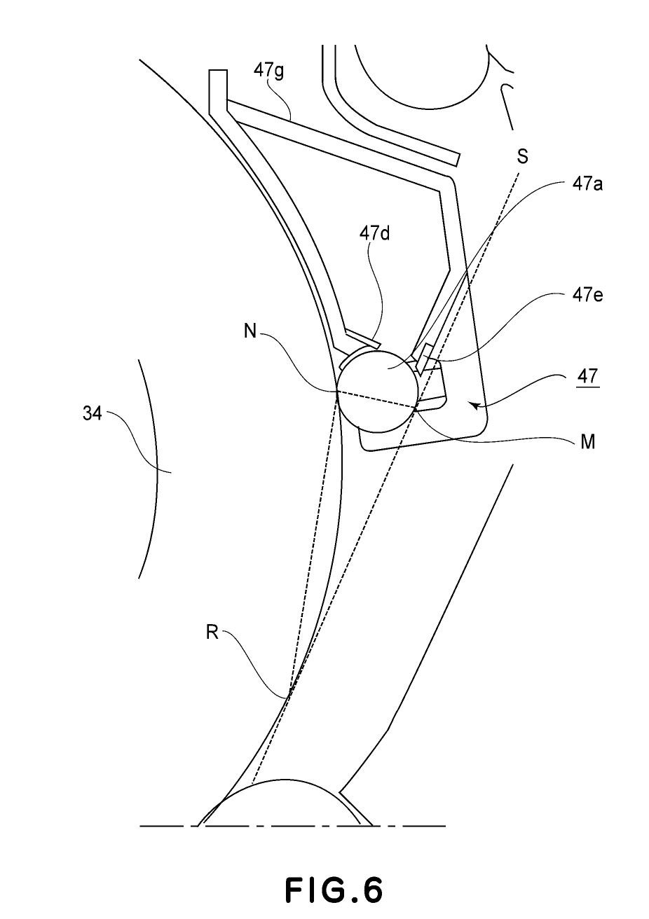

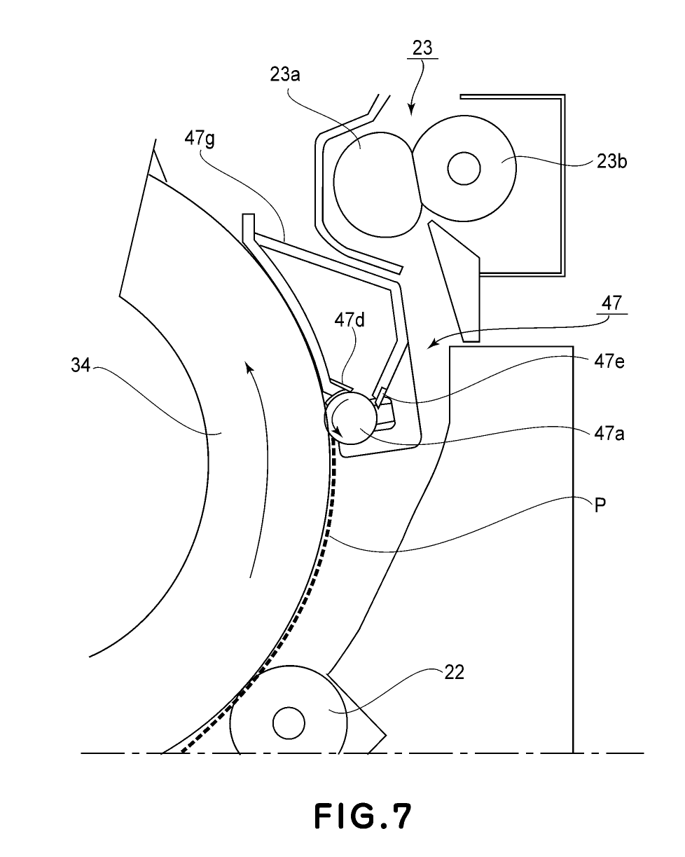

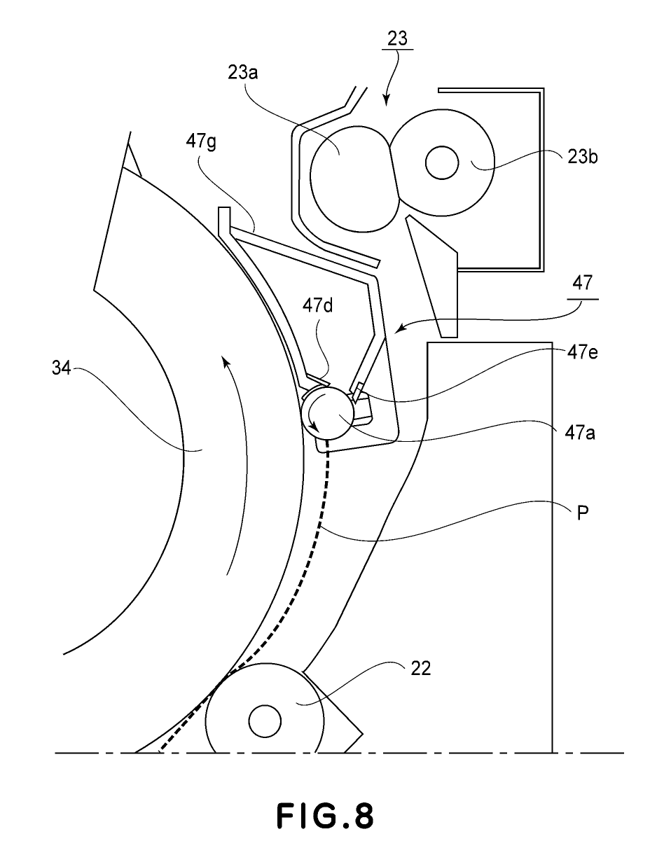

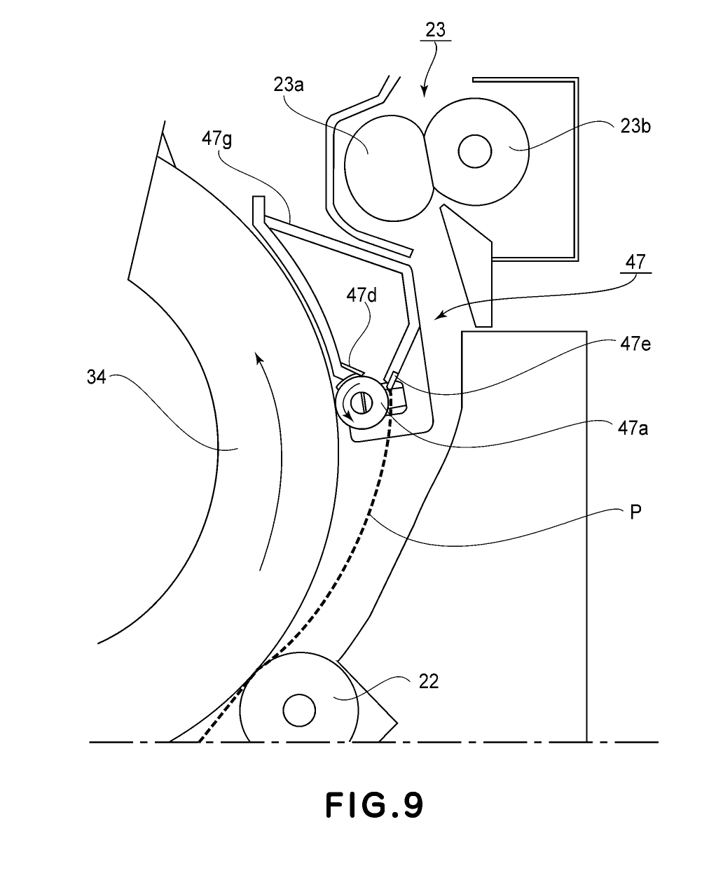

Next, a state until the sheet P is separated from the intermediary transfer drum 34 in the case where the sheet P on which the toner images are transferred is wound about the intermediary transfer drum 34 will be described with reference to FIGS. 4 to 9. FIG. 4 is a perspective view of an outer appearance of an intermediary transfer drum cleaning unit 47 for cleaning the surface of the intermediary transfer drum 34. FIG. 5 is a sectional view for illustrating a common tangential line S of the intermediary transfer drum 34 and a cleaning roller 47a disposed on a downstream side of the secondary transfer roller 22 and on an upstream side of the photosensitive drum 32a with respect to a rotational direction of the intermediary transfer drum 34. The cleaning roller 47a cleans the surface of the intermediary transfer drum 34 in contact with the intermediary transfer drum 34 as the intermediary transfer member. Further, the cleaning roller 47a may also be constituted by a fur brush. FIG. 6 is a sectional view showing an area connecting the common tangential line S of the intermediary transfer drum 34 and the cleaning roller 47a with contact points with respect to the respective rollers. FIGS. 7 to 9 are sectional views showing the state until the sheet P is separated from the intermediary transfer drum 34.

The intermediary transfer drum cleaning unit 47 includes a cleaning unit frame 47f, the cleaning roller 47a as a rotatable cleaning member, a cleaning roller bearing 47b, a cleaning roller urging spring 47c, a cleaning blade 47d, a Myler sheet 47e and a residual toner container 47g. The cleaning roller 47a is rotationally driven by a driving unit (not shown) with the cleaning roller bearing 47b as the center. The driving unit at least includes a driving motor for transmitting a driving force. The driving unit also includes a drive transmission portion for rotating a rotation shaft of the cleaning roller 47a. By the driving force transmitted from the driving motor through the drive transmission portion, the cleaning roller 47a is rotatable.

At this time, the rotational direction of the cleaning roller 47a is set to be opposite from that of the intermediary transfer drum 34 during image formation. Further, the cleaning roller bearing 47b is urged by the cleaning roller urging spring 47c, so that the cleaning roller 47a is urged against the intermediary transfer drum 34 with a predetermined urging pressure. A cleaning roller bearing holding portion 47h of the cleaning unit frame 47f, the cleaning roller bearing 47b and the cleaning roller urging spring 47c are disposed sufficiently outside widthwise ends of the sheet P having a maximum width which can be passed through the fixing means 23 of the image forming apparatus 100 with respect to a sheet width direction. As a result, by the constitution, the conveyance of the sheet is not prevented.

Further, in FIGS. 5 and 6, a contact point M, between the cleaning roller 47a and the common tangential line S of the intermediary transfer drum 34 and the cleaning roller 47a, which is located in a conveyance area with respect to the sheet width direction in which the sheet P is conveyed. Further, a contact point N between the intermediary transfer drum 34 and the cleaning roller 47a and a contact point R between the common tangential line S and the intermediary transfer drum 34 are shown in FIGS. 5 and 6. In the sheet conveyance area with respect to the sheet width direction and in the spatial area defined by three lines connecting these three contact points, only the cleaning roller 47a is contacted to the intermediary transfer drum 34 and is partly exposed. That is, the common tangential line S simultaneously contacting the surface of the intermediary transfer drum 34 and the surface of the cleaning roller 47a on the upstream side of the contact point N, with respect to the rotational direction of the intermediary transfer drum 34, between the intermediary transfer drum 34 as the intermediary transfer member and the cleaning roller 47a as the rotatable cleaning member is considered. Then, a spatial area defined by three lines connecting the three portions, i.e., the cleaning roller R between the common tangential line S and the surface of the intermediary transfer drum 34, the contact point M between the common tangential line S and the surface of the cleaning roller 47a, and the contact point N between the intermediary transfer drum 34 and the cleaning roller 47a is considered. In the spatial area and in the sheet conveyance area with respect to the sheet width direction, only the intermediary transfer drum 34 and the cleaning roller 47a and disposed. In the spatial area defined by connecting the three points, the cleaning roller 47a is exposed. The common tangential line S of the intermediary transfer drum 34 and the cleaning roller 47a is determined as follows. That is, as shown in FIG. 5, rectilinear lines contacting an outer circumferential line of the intermediary transfer drum 34 and an outer circumferential line of the cleaning roller 47a at points other than the contact point N between the intermediary transfer drum 34 and the cleaning roller 47a is considered. Of these rectilinear lines, a rectilinear line contacting the outer circumferential line of the intermediary transfer drum 34 on an upstream side with respect to the rotational direction of the intermediary transfer drum 34 is the common tangential line S.

The case where the sheet P on which the toner images are transferred is conveyed to the cleaning roller 47a while sticking to the intermediary transfer drum 34 is considered. In this case, in a state in which the cleaning roller 47a contacts the intermediary transfer drum 34 with the predetermined pressure, a leading end portion of the sheet P is separated from the intermediary transfer drum 34 by the cleaning roller 47a rotationally driven in the opposite direction to the rotational direction of the intermediary transfer drum 34 during the image formation, as shown in FIGS. 7 to 9. Here, in the conveyance area, with respect to the sheet width direction in which the sheet P is conveyed and in the area connecting the contact points M, N and R described above. For this reason, the leading end portion of the separated sheet P is easily introduced into a downstream side with respect to the sheet conveyance direction by the rotation of the cleaning roller 47a without being wound about or caught by a peripheral member such as a member or the like constituting the intermediary transfer drum cleaning unit 47. Further, the intermediary transfer drum cleaning unit 47 includes the Myler sheet 47e, so that the leading end portion of the sheet P introduced by the rotation of the cleaning roller 47a is conveyed without being wound about the cleaning roller 47a. Further, the cleaning roller 47a may also be rotationally driven in the opposite direction to the rotational direction of the intermediary transfer drum 34 during the image formation at least in a period from the contact of the leading end of the sheet P with the cleaning roller 47a to the separation of the sheet P from the intermediary transfer drum 34. For example, with timing when the leading end of the sheet P passes through the secondary transfer nip, the contact for contacting the driving unit may also switch the rotational direction of the cleaning roller 47a from the same rotational direction as the intermediary transfer drum during the image formation to the opposite rotational direction to the rotational direction of the intermediary transfer drum 34 during the image formation.

The sheet P conveyed without sticking to the intermediary transfer drum 34 or the sheet P separated from the intermediary transfer drum 34 by the cleaning roller 47a through the process described above is introduced into the fixing device (means) 23 in which the sheet P is to be heated and pressed in a fixing nip. As a result, color mixing and fixing of the respective toner images on the sheet P are effected. Then, the sheet P comes out of the fixing device 23 and is discharged on the discharging tray 25 by a discharging roller pair 24 as an image-formed product.

Secondary transfer residual toner remaining on the surface of the intermediary transfer drum 34 after the separation of the sheet P is removed by the cleaning blade 47d from surface of the cleaning roller 47a and is collected in the residual toner container 47g.

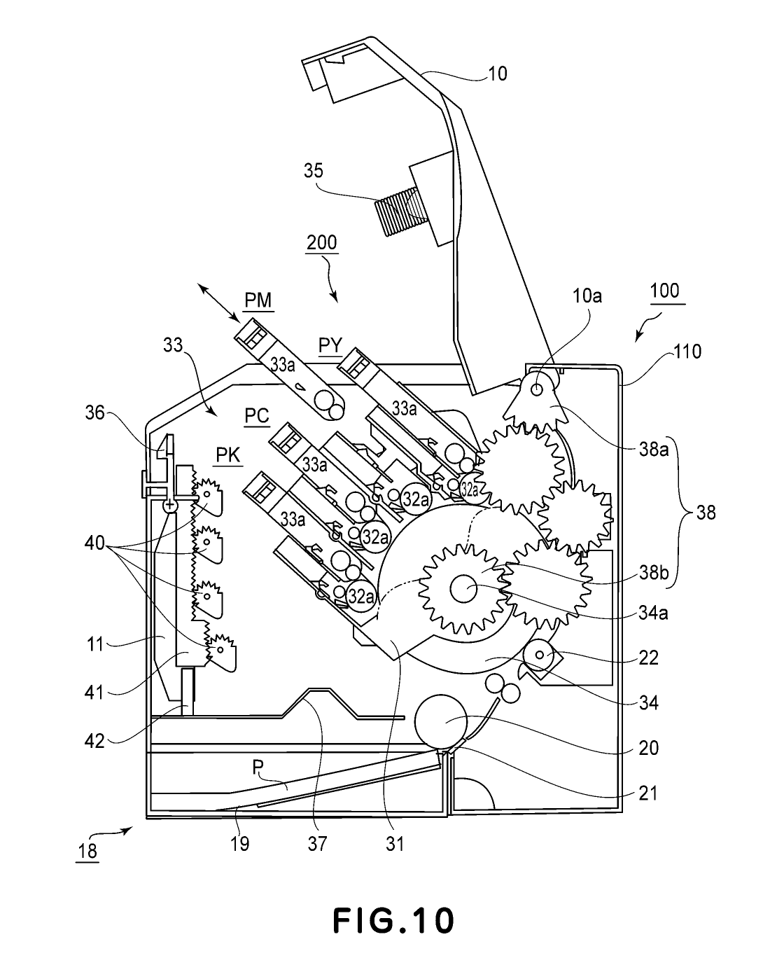

Next, a developing cartridge exchanging operation of the image forming unit 200 in the image forming apparatus 100 will be described. FIG. 10 is a schematic view showing a state in which the maintenance cover 10 as a casing member which can be freely opened to a mounting and dismounting position in which the developing cartridge 23 is mountable and dismountable. Incidentally, as shown in FIG. 10, a maintenance gear train 38, an urging member 40, an urging rack 41, and an urging rack spring 42 are disposed.

At an upper portion of the casing, the maintenance cover 11 covering the upper surface portion of the image forming apparatus 100 and is rotatable about a hinge portion 10a. When the user opens the maintenance cover 10 toward above the apparatus main assembly 100, a driving force is transmitted from a gear 38a of the maintenance cover 10 to a gear 38b of the sub-frame 31 through the maintenance gear train 38. Then, the image forming unit 200 is rotationally moved to the mounting and dismounting position for the developing cartridge 33, so that the mounting and dismounting of the developing cartridge 33 through an upper opening of the apparatus main assembly 100 can be performed. That is, the image forming unit 200 including the intermediary transfer drum 34 and the developing unit consisting of a single or a plurality of developing device cases 33a as the developer holding unit has a first attitude in which the image forming unit 200 effects the image formation in the image forming apparatus 100. Further, the image forming unit 200 has a second attitude in which the attitude of the image forming unit 200 is changed from the first attitude so as to permit the mounting and dismounting of the developing device case 33a through the opening. In the second attitude, the laser scanner unit 11 as the exposure unit and the maintenance cover 10 as the openable casing member integrally perform the opening operation to create the opening through which the developing device case 33a is mountable and dismountable. The movement between the first attitude and the second attitude is rotational movement about the center shaft 34a of the intermediary transfer drum 34.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 248062/2009 filed Oct. 28, 2009, which is hereby incorporated by reference.

What is claimed is:

1. An image forming apparatus comprising:
an image bearing member for bearing a toner image;
an intermediary transfer member which is rotatable and onto which the toner image borne on said image bearing member is to be transferred in contact with said image bearing member;
a transfer unit for transferring the toner image from said intermediary transfer member onto a sheet: and
a rotatable cleaning member for cleaning said intermediary transfer member in contact with said intermediary transfer member, said rotatable cleaning member being disposed downstream of said transfer unit with respect to a sheet conveyance direction and being to be rotated in an opposite direction to a rotational direction of said intermediary transfer member during image formation;
wherein said rotatable cleaning member is capable of separating a sheet wound about said intermediary transfer member from said intermediary transfer member, and
wherein, in a sheet conveyance area with respect to a sheet width direction and in a spatial area defined by three lines connecting three points consisting of a contact point between a common tangential line and said intermediary transfer member, a contact point between the common tangential line and said rotatable cleaning member, and a contact point between said intermediary transfer member and said rotatable cleaning member, said common tangential line being simultaneously in contact with a surface of said intermediary transfer member and a surface of said rotatable cleaning member on an upstream side of the contact point between said intermediary transfer member and said rotatable cleaning member with respect to the rotational direction of said rotatable cleaning member, only said rotatable cleaning member is contacted to said intermediary transfer member.

2. An apparatus according to claim 1, further comprising a fixing unit for fixing an unfixed toner image transferred onto the sheet by said transfer unit,
wherein said fixing unit is disposed above the common tangential line.

3. An apparatus according to claim 1, further comprising a driving unit for driving said rotatable cleaning member,
wherein said driving unit is rotated in the opposite direction to the rotational direction of said image bearing member or said intermediary transfer member during image formation until at least a leading end of the sheet is separated from said image bearing member or said intermediary transfer member.

4. An apparatus according to claim 1, wherein said rotatable cleaning member is a fur brush.

5. An apparatus according to claim 1, wherein said intermediary transfer member is an intermediary transfer drum.
